(19) United States
(12) Patent Application Publication
(10) Pub. No.: US 2020/0089505 A1
(43) Pub. Date: Mar. 19, 2020

(54) Method for Creating Identifiers for Information Units in a Distributed System

(71) Applicant: Siemens Aktiengesellschaft, Muenchen (DE)

(72) Inventors: Helmut Kapoun, Wien (AT); Jaroslaw KUSSYK, Wien (AT)

(21) Appl. No.: 16/569,244

(22) Filed: Sep. 12, 2019

(30) Foreign Application Priority Data
Sep. 13, 2018 (EP) EP18194166.7

(51) Int. Cl. G06F 9/38; G06F 3/06; G06F 16/9035

(52) U.S. Cl. CPC G06F 9/3891; G06F 3/067; G06F 16/9035; G06F 3/0623; G06F 3/0679; G06F 3/0658

(57) ABSTRACT

A method for creating identifiers for information units in a distributed system, wherein respective ways of functioning of functional units, in particular software modules and/or hardware units, in the distributed system are defined by the assignment of information units, where associated identifiers are created for respective information units and assigned to these for identification and/or addressing, a unique component identification of a component of the distributed system is employed for the generation of an identifier, the unique component identification is combined by a respective current counter value of a counter unit comprising each component of the distributed system, which has the unique component identification used, and where after generation of the respective identifier the counter value is incremented and the incremented counter value is stored in the counter unit as the respective current counter value.

### BACKGROUND OF THE INVENTION

### 1. Field of the Invention

The present invention relates to a method for creating identifiers for information units in a distributed system, where respective ways in which functional units, in particular software modules and/or hardware units, function in the distributed system are defined by assignment of information units, and where associated identifiers are created for each case of the respective information units and assigned to these for identification and where necessary for addressing of the respective information units.

### 2. Description of the Related Art

Nowadays in many areas, such as in the energy area, as systems for energy generation, energy distribution and energy transmission or in various areas of industry, such as manufacturing plants, distributed systems, which are also constructed from a plurality of different units such as hardware components and software modules, are employed in process technology.

In such cases, the units of a distributed system are coupled to one another within the framework of a specific architecture and handle tasks cooperatively together. A logical distribution of functions or functional units, in particular software modules or instances, to the components of the distributed system, in particular to the hardware units, can go hand in hand with a physical decentralization in a network tailored thereto. In such cases, a functional unit has a specific functionality or way of functioning, which is then executed by the respective component or on the respective hardware unit.

In order to obtain a specific functionality or way of functioning, what are known as entities are generated for the functional units in a configuration and/or parameterization, for example, and then assigned to these units. An entity, which can also be referred to as an information unit or information object, is designated in information technology, in particular in data modeling, as an object to be defined uniquely, via which information is to be stored or processed. An entity can be modeled or generated as an information unit with defined attributes, for example, where the respective attributes and/or parameters comprise an identifier, for the respective entity or information unit. With the aid of this identifier the functionality that is defined by the entity or information unit is uniquely identified and, if necessary, addressed.

An entity is designated, for example, as a data unit with configuration data, parameters, identifiers and/or further attributes. Furthermore, however, what is referred to as device firmware or software, a loadable application, executable program code and/or a configuration able to be made for an integrated, electronic component (e.g., FPGA), etc. can also be seen as an entity or information unit, through which in each case in conjunction with corresponding configuration data and parameters a basic way in which a hardware unit or component functions is defined. Such components are, for example, automation devices, electronic components, logical nodes or devices, what are known as Intelligent Electronic Devices (IEDs) or what are known as Remote Terminal Units (RTUs).

IEDs in such cases are usually processor-based control components, which are employed in a wide diversity of devices in energy systems (e.g., transformers, capacitors, contactors, power or isolating switches) and are used for measurement, control and communication. The respective functionality or way of functioning of the IED can then be defined via configuration or via the assignment of the corresponding entity or information unit. RTUs or remote terminal units are usually closed-loop or open-loop control units for remote control, which are used in process technology, in energy transmission, in energy distribution and in energy generation, for example, in order to monitor and/or to remotely control specific processes from a central location (e.g., maintenance center or local control center).

Above all, with complex, distributed systems, such as plants in the energy area or in process technology, for example, it is frequently necessary for the respective entities or information units, as well as the functionality of a component defined in each case via the respective associated identifiers, to be able to be identified uniquely and permanently, such as for engineering and/or maintenance purposes. Sustainably in this case means that a unique creation of future identifiers and a retention of identifiers already created and assigned to information units is made possible even if a functional unit linked to the entity or information unit (above all hardware components) is expanded, replaced and/or (if necessary after a repair) used once again. Furthermore, with decentralized distributed systems, such as plants in the energy area, it can occur in practice for example that during generation, configuration and/or parameterization of entities or information units and the associated identifiers on site no communication connection exists to a central or higher-ranking control instance. This means that it is not possible or is only possible with great effort to check whether the identifier created for an information unit in each case is unique or sustainable in the respective system.

Nowadays, for example, a unique identification of the hardware components on which the information unit is stored or the assigned functional unit runs is frequently used to generate a unique identifier for the information unit. Such a unique identification of a hardware unit is, e.g., a serial number of the hardware unit. This identification can be given as a number or as a character string, for example, created ex-works and inserted into the respective hardware components (e.g. stored therein) or applied to the respective hardware components (e.g., in the form of a barcode, or QR code). In this case, however, there is the disadvantage that the identifier of an information unit is not independent of that hardware component on which the functional unit assigned to the information unit is stated. In particular, in the event of a re-use of a hardware component with the same hardware identification (e.g. after a hardware replacement, after a repair) a repeated creation of identifiers for further information units would be possible. That is, for re-use of the hardware component for a new information unit, for example, an identifier already created and used by another information unit would be generated. Thus, the identifiers (in particular without the use of a central control instance) would no longer be unique in the distributed system.

In order to avoid the shared use of a hardware identification as an identifier for at least two information units, the hardware identification can be used together with a current time for creation of the identifier, for example, where the current time must be reliably provided by the respective hardware component, for example. However, in practice the current time is frequently not available, for example, because it is not set in the respective hardware component or is only transferred from a higher-ranking system (e.g., from a central control instance) or originates from an unreliable source, which can only be verified and used, for example, after generation of the entity or information unit and the associated identifier.

A method is known from the publication “Leach, P.; Mealling, M.; Salz, R.; “A Universally Unique Identifier (UUID) URN Namespace”, Network Working Group; Request for Comments 4122, The Internet Society; July 2005.” in which an identifier is formed on the basis of a random number. The random number is created by a random generator or a dummy random generator from a sufficiently large set of numbers. In this way, the probability of a creation of at least two identical identifiers for different information units will in effect be significantly reduced. However, this probability is not zero. Furthermore, a random generator or a high-quality, independent dummy random generator is not always available, particularly with distributed systems to be configured and maintained decentrally.

### SUMMARY OF THE INVENTION

In view of the foregoing, it is therefore an object of the invention to provide a method for creating identifiers that are assigned to information units for identification in a distributed system in which, in a simple and secure way, a uniqueness and sustainability of the identifiers, particularly for expansion, replacement and re-use of individual hardware components, is insured.

This and other objects and advantages are achieved in accordance with the invention by a method for creation of identifiers for information units in a distributed system, where a respective way of functioning or functionality of this functional unit in the distributed system is defined via assignment of an information unit to a functional unit. Furthermore, on creation of the respective information unit, a respective associated identifier is generated, which is assigned to the respective information unit for an identification and if necessary an addressing. Here, a unique component identification of a component, in particular of a hardware unit, of the distributed systems is employed for a generation of the identifier. This unique component identification is combined with a respective current counter value of a counter unit, where the counter unit is included for each component to which the unique component identification used is assigned. After generation of the respective identifier, the counter value is incremented and the incremented counter value is stored in each case as the current counter value in the counter unit.

The main aspect of the inventive method primarily consists of it being guaranteed by the creation of the respective identifier based on a unique component identification stored in a component (ideally a hardware ID) and a current counter value stored in the counter unit of the same component that even identifiers created in the future remain unique, even without use of or linkage to a central control instance. This uniqueness is retained even when a hardware component is replaced and is used (again) in another system unit of the distributed system.

This means that, through the inventive method, the created identifier (despite the use of the component identification) becomes independent of the component or hardware unit from which the component identification originates. This is in particular advantageous when what is referred to as a computer cloud or multiprocessor system is used as the hardware or system, for example, in which a number of component identifications or hardware IDs are available and the respective information units for the respective identifiers can no longer be uniquely assigned or in which not all components have component identifications or hardware IDs.

Furthermore, an information unit can ideally be transferred without any great effort to a new component (e.g., on replacement of the hardware component). The hardware independence of the identifier created with the inventive system means that the identifier is not required to be adapted to the new component. The effort of adaptation and configuration when hardware is replaced therefore remains comparatively small.

Furthermore, above all through the hardware independence of the identifiers, the inventive method provides the opportunity for each information unit or entity to be assigned process technology addresses and/or interfaces directly by the identifier assigned. This is in particular of advantage when a number of information units, by which, e.g., process interfaces with a fixed assignment to them are operated, are to be transferred, for example, from a number of hardware components each with their own hardware IDs to a shared hardware component with a single hardware ID or conversely distributed from one shared hardware component to a number of components or modules (if necessary without their own hardware ID).

It is advantageous for access to the counter unit to be at least restricted during the generation of the information unit and the respective associated identifier. In this case, a memory access to the counter unit and possibly a read access to the counter unit is ideally restricted or blocked, so that the counter values of the respective counter unit used for the creation of the identifiers can be kept consistent. After generation of the information unit and the respective associated identifier, access to the counter unit can be enabled again, in order to store the incremented counter value as the current counter value, for example.

Ideally, the counter unit of the respective component is initialized with a defined start value. The counter unit of the respective component can be initialized for example by a manufacturer of the component (e.g., ex-works) or this can be performed during a first initialization of the component. Any given integer value or zero can be used as the defined start value, for example.

In a preferred embodiment of the invention, a generation unit to be provided for the generation of the information unit and the respective associated identifier. The generation of a new information unit and the associated identifier via the generation unit can be achieved automatically, in an automated manner or manually. A number of information units with associated identifiers can also be generated in an advantageous manner with the aid of the generation unit, where, for example, the same component identification is used but supplemented by different current counter values. The generation unit can ideally be implemented as a functional unit, which is implemented on the same component or hardware unit for which the respective information unit and the respective associated identifier is generated. That is, the functional unit to which the information unit is assigned is implemented by the component on which the generation unit also runs.

As an alternative, the generation unit can also be implemented on a separate or on its own component. This component can then be linked via a communication link, (e.g., a gateway, a proxy server, a router, or a bridge) to that component for which the respective information unit and the respective associated identifier is generated. The separate component on which the generation unit runs can also be linked via a direct communication connection, such as a bus connection, a LAN connection or the Internet, to that component for which the respective information unit and the respective associated identifier is generated. The generation unit can then communicate directly with this component. Depending on availability, the component identification and the respective current counter value of the component on which the generation unit is implemented, or the component identification and the respective current counter value of the component of the gateway unit or the component identification and the respective current counter value of that component can be used for the generation of the respective identifiers for the respective information units.

In an expedient embodiment of the inventive method, the respective information unit and the respective associated, created identifier is stored in a memory unit with additional status and/or generation information. In this case, for example, each respective counter value used for the created identifier can be stored as a number and in this simple way all identifiers or associated information units created with the same unique component identification can be captured consistently in the memory unit. This number or the corresponding identifier or the corresponding information unit can then be assigned status and/or generation information, such time of generation, time of the last status change, status of the associated information unit (e.g., active, invalid, released for use, inactive, blocked, or erased).

Furthermore, in an advantageous manner, information stored in the memory unit about the respective identifiers created is processed with the aid of the generation unit. In particular, the status information about the respective identifiers can be supplemented or updated in a simple way by the generation unit if, for example, an information unit or the associated identifier is declared invalid, is released for use, is (temporarily) blocked or has been or is to be erased. If, for example, an information unit and thus the associated identifier captured in the memory unit have been erased then, for example, this identifier can be used for another information unit. This can be shown in the memory unit, for example, by a corresponding change in the status information of the respective information unit or the respective identifier. However, a corresponding entry in the memory unit can also be erased. The memory unit can be arranged, for example, in the component for which the respective information unit was created, or in the component on which the generation unit is running.

It is furthermore useful for additional identification information to be used for the generation of the identifier for the respective information unit. Through this, it is additionally insured that the respective identifiers of the respective information units are unique and sustainable. A current time or point in time of generation, a time stamp, a so-called MAC address of the respective component, a node identification, version information (e.g., of a software module, or firmware), a type code, name, or name range can be used as additional identification information, for example.

The respective information unit and the associated identifier can preferably be stored after an assignment to the respective functional unit or transmission to the respective component in a non-volatile or power outage-proof memory element. Non-volatile, electronic memory chips, such as Read-Only-Memories (ROMs) or Electrically Erasable Programmable Read-Only-Memories (EEPROMs) or read-only memories can be used as memory elements for this purpose, for example. As an alternative, power outage-proof memories of a so-called crypto chip or other secure data media can be used for the memory elements.

It is likewise advantageous for the component identification, which is employed for the generation of the respective identifier, and the respective current counter value of the counter unit to be stored in a non-volatile or power outage-proof memory element on the respective component. The component identification can be inserted into the component, for example, by a manufacturer of the component (e.g., ex-works) or be introduced into the component during a first initialization of the component. For an introduction during a first initialization, the component identification can be transmitted into the non-volatile memory element by manual input or by scanning a bar code or QR code that contains the component identification for example. Non-volatile, electronic memory chips, such as Read-Only-Memories (ROMs) or Electrically Erasable Programmable Read-Only-Memories (EEPROMs) or read-only memories can likewise be used as non-volatile memory elements.

Ideally the component identification, the respective current counter value of the counter unit and also the respective identifiers of the respective information units are stored encoded. This can be as a hash value, for example, or supplemented by a checksum or check sequence or as a digital signature or as a result of corresponding transformations, in order to make possible an encryption or authentication of the respective identifier and/or a recognition of any bit errors that might occur and if necessary their correction.

If for a component or hardware unit of the distributed system a reading out of the respective current counter value from the counter unit or the respective component identification is no longer possible or if the respective current counter value or the respective component identification is no longer consistent and/or trustworthy (e.g., after a consistency check, checksum/check sequence, hash, signature check), then the respective component or hardware unit with the associated component identification can no longer be used for the creation of identifiers for information units. The corresponding component should be replaced and/or repaired, for example, and may then only be used again after a repair or a replacement if a last-used consistent and trustworthy counter value of the counter unit included in the component and/or a consistent and trustworthy component identification is available or able to be restored. A repair of the component in such cases is also to be seen, for example, as a complete or partial replacement of this component by a functionally equivalent component or hardware unit.

If a last-valid consistent and trustworthy counter value of the counter unit included in the repaired or replaced component and/or a consistent and trustworthy component identification is no longer available or has been lost, then the repaired component or the replacement component may only be used with a new, unique component identification for the creation of identifiers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained below by way of example with reference to the enclosed figures, in which:

FIG. 1 shows a schematic example of an execution of the inventive method for creating identifiers for information units in a distributed system;

FIG. 1 shows a schematic example of an execution of the inventive method for creating identifiers for information units in a distributed system;

FIG. 2 shows an exemplary first embodiment of the inventive method with separate components for generating and running the information units;

FIG. 3 shows an exemplary second embodiment variant of the inventive method with separate components for generating and running the information units;

FIG. 4 shows an example of a third embodiment variant of the inventive method with separate components for generating and running the information units;

FIG. 5 shows an example of an embodiment variant of the inventive method on replacement of a component; and

FIG. 6 shows a flowchart of the method in accordance with the invention.

### DETAILED DESCRIPTION OF THE EXEMPLARY EMBODIMENTS

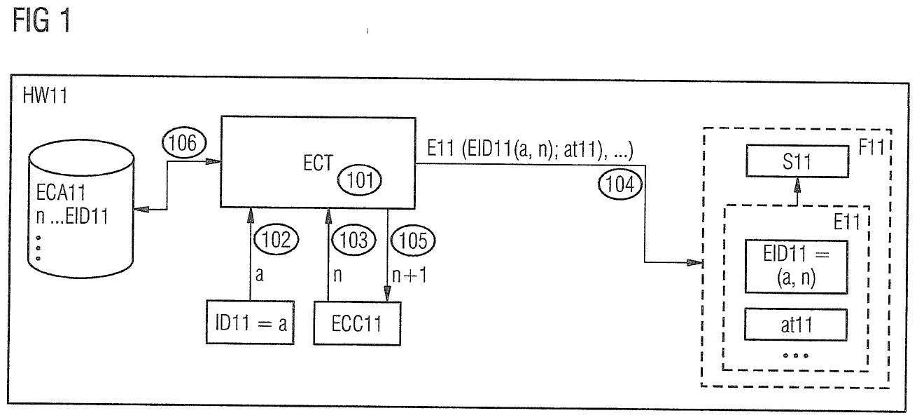

FIG. 1 shows a schematic example of an execution sequence of the inventive method for creating an identifier EID11 for an information unit E11 in a distributed system. The new information unit or entity E11 to be generated is to be assigned after its generation to a functional unit S11, e.g., software instance or hardware unit which, through the assignment of the information unit E11, obtains a way of functioning or functionality F11. The functionality F11 is then capable of running and/or can be executed on a component HW11 (e.g., hardware unit). Such an information unit E11 or entity E11 can, for example, be just one data record with configuration data and/or parameters or with device firmware/software, a loadable application, or executable program code, through which, in conjunction with corresponding configuration data and/or parameters, the basic way of functioning or functionality F11 of a component (e.g., hardware unit, automation device, node, IED, or RTU) is defined. To this end, the information unit E11 comprises corresponding data or attributes at11 and also an associated identifier EID11, through which the information unit E11 can be uniquely identified or if necessary addressed in the distributed system. The identifier EID11 is created during the generation of the information unit E11.

A generation unit ECT can be provided for generation of information units E11 and of the associated identifiers EID11. The generation unit ECT can, as shown by way of example in FIG. 1, be implemented as a functional unit, which is implemented on the same component HW11 as the functional unit S11 or the functionality F11, for which the information unit E11 and the associated identifier EID11 is generated.

The component HW11 has unique component identification ID11 with a value a, which is stored in the component HW11, e.g., in a non-volatile or power outage-proof memory element (e.g., ROM, EEPROM). The unique component identification ID11 can be stored encoded, for example. A hardware serial number, a unique, process-technology address or communication address, can be used as the unique component identification ID11, for example. The unique component identification ID11 can be introduced into the component HW11, for example, during a first initialization (for example during an installation of the component HW11) such as by scanning a bar code or QR code that contains the component identification ID11, or can be introduced by manual entry into the component HW11 or the corresponding memory element. The introduction of the unique component identification ID11 can be performed, for example, with the aid of the generation unit ECT. As an alternative, the component HW11 can already have a unique component identification stored in it, which has been introduced for example into the component HW11 ex-works or by the manufacturer, such as a serial number (and a version number).

Furthermore, the component HW11 comprises a counter unit ECC11, which is implemented as a non-volatile or power outage-proof memory element of the component HW11 or as parts of a non-volatile memory element of the component HW11, for example. Stored in the counter unit ECC11 can be a respective current counter value n, which is ideally stored encoded in the counter unit ECC11. Before the inventive method is performed for the first time, the counter unit ECC11 is initialized with a defined start value. The counter unit ECC11 of the component HW11 can be initialized for example by a manufacturer of the component (e.g., ex-works) or this can be performed during the first initialization or installation of the component HW11. Any given integer value n or the value zero can be used as the defined start value, for example.

If a new information unit E11 with attributes at11 and a unique, associated identifier EID11, e.g., as first attribute is now to be generated on the component HW11 for a functional unit S11, then the creation of the new information unit E11 is started, with the aid of the generation unit ECT in a generation start phase 101, for example.

The unique component identification ID11 of the component HW11 is employed to generate the identifier EID11 for the new information unit E11. To this end, in an identification readout phase 102, the value a of the unique component identification ID11 is read out from the non-volatile memory element by the generation unit ECT. With an encoded storage of the component identification ID11 this can still be checked for consistency and trustworthiness.

In a generation phase 103, the current counter value n is read out from the counter unit ECC11 by the generation unit ECT, for example. To this end, an access to the counter unit ECC11 is ideally at least restricted during the entire generation of the new information unit E11 and the associated identifier EID11. That is, in particular, a storage or write access to the counter unit ECC11 is blocked for the creation of the new identifier and a read access is at least restricted. Furthermore, in the generation phase 103 the component identification ID11 or the value a of the component identification ID11 is combined with the respective current counter value n that has been read out from the counter unit ECC11. The new identifier EID11 for the new information unit E11 is thus generated as a combination of the unique component identification ID11 or its value a and the respective current counter value n of the counter unit ECC11. In this case, it is important for the component identification ID11 and the respective current counter value n of the counter unit ECC11 to originate from the same component HW11 or to be stored on the same component HW11.

Additional identification information can also still be employed for the generation of the new identifier EID11. A current time or point in time of the generation, a time stamp, a MAC address of the respective component, a node identification, version information (e.g. of a software module, or firmware), a type code, name, or name range can be used as additional identification information for example.

After generation of the new information unit E11 with the respective attributes at11 and the associated identifier EID11, in an assignment phase 104, the information unit E11 for a configuration of the functional unit S11 is assigned as functionality F11. In this case, the information unit E11 with the associated identifier EID11 can be stored as the first attribute and further attributes atl 1 in a non-volatile memory element, such as an EEPROM, on the component HW11. The information unit E11 with the associated identifier EID11 and attributes at11 can likewise be stored encoded.

In an incrementation phase 105 the counter value n, which was read out in the generation phase 103 from the counter unit ECC11, is incremented and thus a new current counter value n+1 created. The incrementation of the respective current counter value n can be performed for example, by the generation unit ECT. After the incrementation, the incremented counter value n+1 is stored in the incrementation phase 105 as the new current counter value n+1 in the counter unit ECC11.

If a further information unit with a respective, associated identifier is to be generated for the component HW11 for the configuration of a further functional unit with the aid of the generation unit ECT, then the phases of the inventive method are run again: The generation start phase 101, the identification readout phase 102 for reading out the unique component identification ID11 with the value a, the generation phase 103 for generating the corresponding, unique identifier, the assignment phase 104 and the incrementation phase 105. However, in the generation phase 103, the value a of the component identification ID11 is combined with the current counter value n+1 from the counter unit ECC11 of the component HW11. Then, in the incrementation phase 105, the counter value n+1 is incremented and in this process a value n+2 is obtained as a new counter value, for example, which is then stored as the new current counter value in the counter unit.

In addition in an archiving phase 106, the respective information unit E11 and the respective associated identifier EID11 can be stored in a memory unit ECA11, which is likewise included in the component HW11. In such cases, for example, the counter value n used for the identifier E11 can be stored as a number. This number n or the corresponding identifier EID11 can be assigned status or generation information, for example, generation time, time at which the status was last changed, status of the associated information unit (e.g., active, invalid, released for use, inactive, blocked, or erased). The information held in the memory unit ECA11 for the identifier E11 can then be processed via the generation unit ECT, for example. In this way, for example, the status information of the identifier EID11 can be supplemented, changed or updated. It can be shown, by a corresponding change to the status information of the information unit E11 or of the associated identifier EID11, in the memory unit ECA11, for example, when the information unit E11 or the associated identifier EID11 has been or is to be declared invalid, released for use, (temporarily) blocked or erased.

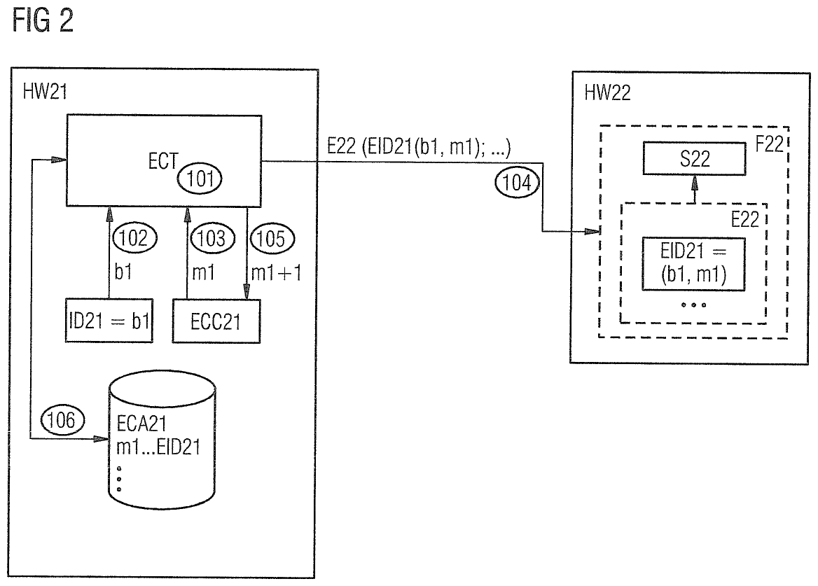

As an alternative to the embodiment of the inventive method shown by way of example in FIG. 1, in which the generation unit ECT is implemented as a functional unit on the same component HW11 for which the information unit E11 is created, the generation unit ECT can be implemented as a functional unit of a separate component. Shown in FIG. 2, by way of example, is a first embodiment of the inventive method, in which the generation unit ECT is implemented on a separate, first component HW21.

As well as the generation unit ECT, the first component HW21 has a unique component identification ID21 with a value b as well as a counter unit ECC21 in which a current counter value m is stored. The functional unit F22, which is to be configured via the information unit E22 as functionality F22, is located on a second component HW22 or a target component HW22. The second component HW22 does not have any component identification or does not have a unique component identification. The first and the second component are connected directly to one another by means of a communication connection (e.g., bus system, LAN connection, or Internet).

To create an information unit E22 for configuring the functional unit S22 on the second component HW22 as well as the associated identifier EID21, the creation of the new information unit E22 is started again, for example, on the first component HW21 in the generation start phase 101 with the aid of the generation unit ECT.

Then, in the identification readout phase 102, for the generation of the associated identifier EID21, the unique component identification ID21 with the value b1 of the first component HW21 is employed by the generation unit ECT, because the second component HW22 does not have any unique component identification for example. In the generation phase 103, the current counter value m is read out from the counter unit ECC21 of the first component HW21, e.g., by the generation unit ECT and combined with the unique component identification ID21 or its value b1. The new identifier EID21 for the new information unit E22 is thus generated as a combination of the unique component identification ID21 or its value b1 and the respective current counter value m1 of the counter unit ECC21, where both values b1, m1 originate from the first component HW21.

After generation of the information unit E22 and the associated identifier EID21, in the assignment phase 104, the information unit E22 is transferred to the second component HW22 and assigned to the functional unit S22 for configuration as functionality F22. The information unit E22 with the associated identifier EID21 can be stored encoded, for example, in a non-volatile memory element, such as an EEPROM, on the second component HW22.

Then, in the incrementation phase 105, the counter value m1, which has been read out from the counter unit ECC21 of the first component HW21 in the generation phase 103, is incremented by the generation unit ECT, for example, and thus a new current counter value m1+1 created. After the incrementation, the incremented counter value m1+1 is stored in the incrementation phase 105 as the new current counter value m1+1 in the counter unit ECC21 of the first component HW21.

Optionally, the archiving phase 106 can be performed again, e.g., by the generation unit ECT. In this phase, the generated information unit E22 or the associated identifier EID21 can be stored in a memory unit ECA21, which is included in the first component HW21, for example. The counter value m1 used for the generation of the identifier E21 can be used as the number, for example.

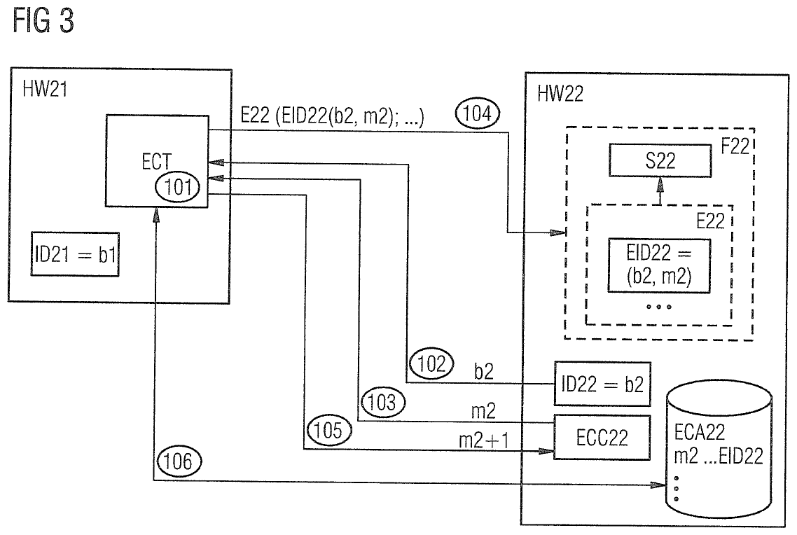

FIG. 3 shows an example of a further second embodiment of the inventive method, where the generation unit ECT is again formed on a separate, first component HW21 with a component identification ID21 with the value b1. The first component HW21 is again connected to a second component HW22 via a direct communication connection (e.g., bus system, LAN connection, or Internet). A functional unit S22 is to be configured as functionality F22 on the second component HW22 via an information unit E22. Unlike the first embodiment shown in FIG. 2, the second component HW22 now has its own unique component identification ID22 with a value b2 as well as a separate counter unit ECC22 with a current counter value m2.

To create the information unit E22 for configuring the functional unit S22 on the second component HW22 as well as an associated identifier EID22, the creation of the information unit E22 is started again, e.g., with the aid of the generation unit ECT on the first component HW21 in the generation start phase 101.

For the generation of the associated identifier EID22, in the identification readout phase 102, the unique component identification ID22 with the value b2 of the second component HW22 is now employed by the generation unit ECT and transferred via the communication connection to the generation unit ECT on the first component HW21. In the generation phase 103, the current counter value m2 is read out from the counter unit ECC22 of the second component HW22, e.g., by the generation unit ECT via the communication connection. The unique component identification ID22 or its value b2 of the second component HW22 is then combined with the current value m2 of the counter unit ECC22 of the second component HW22, e.g., by the generation unit ECT. The identifier EID22 for the new information unit E22 is thus generated as a combination of the unique component identification ID22 or its value b2 and the respective current counter value m2 of the counter unit ECC22, where both values b2, m2 now originate from the second component HW22.

After generation of the information unit E22 and the associated identifier EID22 on the first component HW21, in the assignment phase 104 the information unit E22 is transmitted to the second component HW22 and assigned to the functional unit S22 for configuration as functionality F22. The information unit E22 with the associated identifier EID22 can be stored encoded for example in a non-volatile memory element, such as an EEPROM, on the second component HW22.

In the incrementation phase 105, the counter value m2 from the counter unit ECC22 of the second component HW22 is incremented by the generation unit ECT, for example, and thus a new current counter value m2+1 created. After the incrementation, the incremented counter value m2+1 is transmitted as the new current counter value m2+1 to the second component HW22 and stored there in the counter unit ECC22 of the second component HW22.

Optionally, the archiving phase 106 can be carried out again, e.g. by the generation unit ECT. Here, the generated information unit E22 or the associated identifier EID22 can be stored in a memory unit ECA22, which is included in the second component HW22, for example. The number of the counter value m2 used for the generation of the identifier E22 can be used as the number, for example.

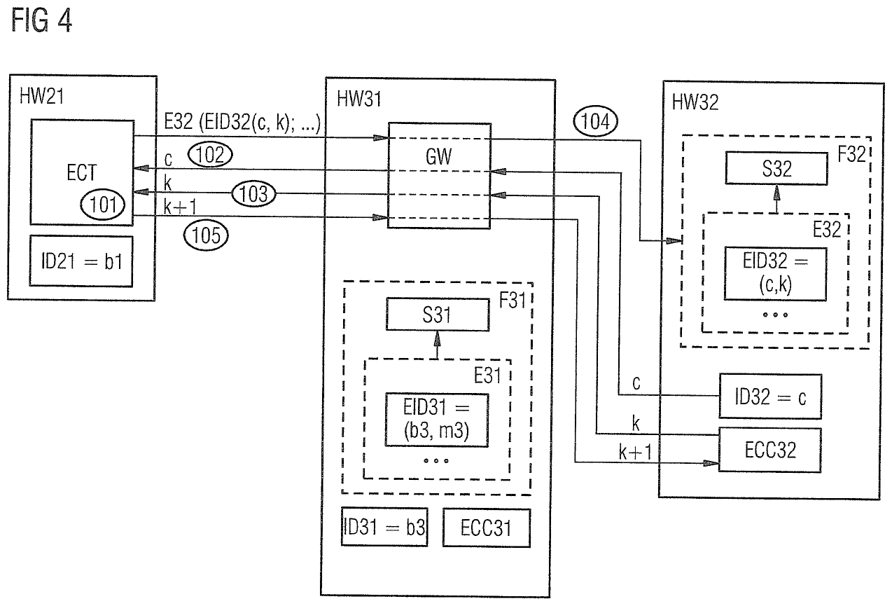

Shown in FIG. 4 is an example of a third embodiment of the inventive method, in which the generation unit ECT is again implemented on a separate, first component HW21 with a component identification ID21 with the value b1. Here, a target component HW32, which has its own, unique component identification ID32 with the value c as well as it own counter unit with a current counter value k for example, is linked indirectly to the first component HW21. That is, the target component HW32 can communicate via a gateway unit GW with the first component HW21 or with the generation unit ECT. The gateway unit GW (e.g., gateway, proxy server, router, or bridge) is accommodated on a second component HW31.

The second component HW31 with its own component identification ID31 with a value b3 and its own counter unit ECC31, as well as the gateway unit GW, for example, has an example of a functional unit S31. The functional unit F31 of the second component HW31 is configured, e.g., via an information unit E31 as functionality F31. The information unit E31 of the second component HW31 as well as an associated identifier EID31 (as shown in FIG. 3, for example) has been generated via the generation unit ECT of the first component HW21. Here, the component identification ID31 with a value b3 of the second component HW31 as well as the corresponding counter value m3 of the counter unit ECC31 of the second component HW31 has been used for the identifier EID, for example.

If an information unit E32 with associated identifier EID32 is now to be generated for configuration of the functional unit S32 of the target component HW32 as functionality F32, then the creation of the information unit E32 as well of the associated identifier EID32 is again started with the aid of the generation unit ECT, for example, on the first component HW21 in the generation start phase 101.

For generation of the associated identifier EID32, the unique component identification ID32 with the value c of the target component HW32 is included in the identification readout phase 102 by the generation unit ECT and, e.g., transferred via the gateway unit GW of the second component HW31 to the generation unit ECT on the first component HW21. In the generation phase 103, the current counter value k is read from the counter unit ECC32 of the target component HW32, e.g., by the generation unit ECT via the gateway unit GW. The unique component identification ID32 or its value c of the target component HW32 is then combined with the current value k of the counter unit ECC32 of the target component HW32, e.g., by the generation unit ECT. The identifier EID32 for the new information unit E32 is thus generated as a combination of the unique component identification ID32 or its value c and the respective current counter value k of the counter unit ECC32, wherein the two values c, k originate from the target component HW32.

As an alternative (when the target component HW32 does not have its own or does not have its own unique component identification ID32 and/or its own counter unit ECC32) the component identification ID31 or its value b3 as well as the respective current counter value m3 of the counter unit ECC31 of the second component HW31 can be included for the generation of the identifier EID32, for example, by the generation unit ECT.

After generation of the information unit E32 and the associated identifier EID32 on the first component HW21, in the assignment phase 104 the information unit E32 is transmitted via the gateway unit GW of the second component HW31 to target component HW32 and assigned to the functional unit S32 for configuration as functionality F32. The information unit E32 with the associated identifier EID32 can be stored in a non-volatile memory element, such as an EEPROM, on the target component HW32, e.g., encoded.

In the incrementation phase 105 the counter value k from the counter unit ECC32 of the target component HW32 is incremented by the generation unit ECT, for example, and thus a new current counter value k+1 is created. After the incrementation, the incremented counter value k+1 can be transmitted again as the new current counter value k+1 via the gateway unit GW to the target component HW32 and stored there in the counter unit ECC32 of the gateway unit GW.

Optionally the archiving phase 106 can be provided again. Here, the generated information unit E32 or the associated identifier EID32 can be stored in a memory unit, which is comprised by the first component HW21, second component HW22 or the target component HW32, for example.

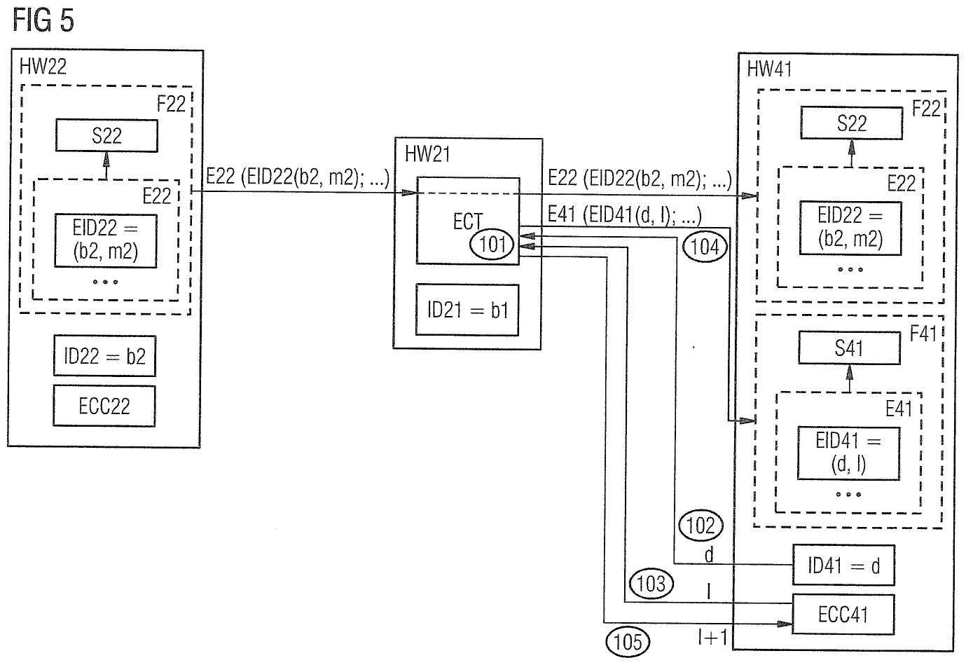

FIG. 5 shows an example of a further embodiment of the inventive method when a replacement component HW41 is used, which has its own unique component identification ID41 with a value d and its own counter unit ECC41 with, e.g., a current counter value I, for example.

Furthermore, the generation unit ECT is again formed separately as a functional unit on the first component HW21 with the component identification ID21 with the value b1. On a second component HW22 (as shown in FIG. 3), a functional unit S22 with an information unit E22 is configured as functionality F22. The information unit E22 has an identifier EID22, which in accordance with the inventive system, has been generated based on a component identification ID22 or its value b2 of the second component HW22 and a current counter value m2 of a counter unit ECC22 of the second component HW22. The second component HW22 is to be replaced as a result of a defect or a repair to be carried out for example, where the functionality F22 is to run on said component without modification.

To this end, the information unit E22 with all attributes, in particular with the associated identifier EID22, is read out, e.g., with the aid of the generation unit ECT of the first component HW21 from the second component HW22, e.g., via a communication connection. For the configuration of the functional unit S22, which either likewise has to be transferred to the replacement component HW41 or is to be newly installed on the component, the information unit E22 is transferred with all attributes, in particular with the associated identifier EID22, into the replacement component HW41, assigned there to the functional unit S22 and stored in a non-volatile memory element (e.g. EEPROM). Through the assignment of the information unit E22 to the functional unit S22 the functionality F22 is then available on the replacement component HW41. The identifier EID22, which was generated on the basis of the component identification ID22 and the counter value m2 of the counter unit ECC22 of the second component HW22, will be retained unchanged.

The transfer of the information unit E22 from the second component HW22 to the replacement component HW41 can be performed manually, in an automated manner or automatically with the aid of the generation unit ECT. A data medium (e.g., USB stick, or SD card) or a direct communication connection between the components HW22, HW41 or via a further component HW21 or via a gateway unit GW can be used for the transmission, for example.

If a further information unit E41 with associated identifier EID41 for configuring a further functional unit S41 as functionality F41 is to be generated for the replacement component HW41, then the phases of the inventive method are run again: the generation phase 101, the identification readout phase 102 for reading out the unique component identification 1D41 with the value d, the generation phase 103 for generating the corresponding, unique identifier EID41, the assignment phase 104 and the incrementation phase 105. In this case, in the identification readout phase 102 the component identification 1D41 with the value d of the replacement component HW41 is read out, e.g., by the generation unit ECT and is combined in the generation phase 103 with a respective current counter value I of the counter unit ECC41 of the replacement component HW41. In the incrementation phase 105, the counter value I of the counter unit ECC41 of the replacement component HW41 is then incremented. The new counter value I+1 obtained in this case is then held as the new current counter value I+1 in the counter unit ECC41 of the replacement component HW41.

For all embodiments of the inventive method shown as examples in FIGS. 1 to 5, the component HW11, . . . , HW41, for which information units E11, . . . , E41 with associated, unique identifier EID11, . . . , EID41 are generated, and/or the component HW11, HW21, on which the generation unit ECT is implemented, can consist of a number of hardware units (e.g., processors, or computers for cloud computing). These hardware units can communicate with one another via a network or communication connections, where for the disclosed embodiments of the inventive method at least one hardware unit HW11, . . . , HW41 must have a separate, unique component identification ID11, . . . , ID41 and a counter unit ECC11, . . . , ECC41.

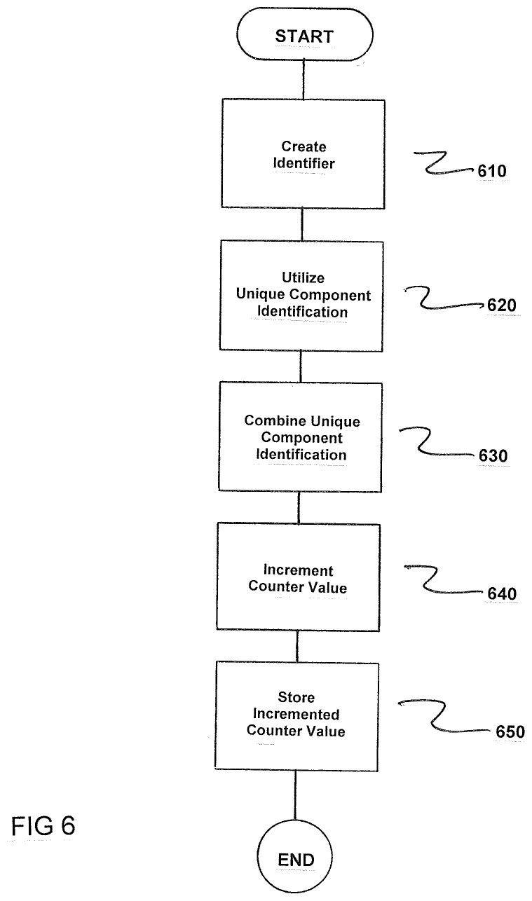

FIG. 6 is a flowchart of the method for creating identifiers EID11, . . . , EID41 for information units E11, . . . , E41 in a distributed system, where a respective way of functioning F11, . . . , F41 of the functional unit S11, . . . , S41 is defined by assignment of a respective information unit E11, . . . , E41 to a functional unit S11, . . . , S41 of the distributed system.

The method comprises creating an identifier EID11, . . . , EID41 which is assigned for identification to the respective information unit E11, . . . , E41 upon generation of the respective information unit E11, . . . , E41, as indicated in step 610.

Next, a unique component identification ID11, . . . , ID41 of a component HW11, . . . , HW41 of the distributed system is utilized for the identifier EID11, . . . , EID41, as indicated in step 620.

Next, the unique component identification ID11, ID41 is combined with a respective current counter value n, m1, m2, . . . , I of a counter unit ECC11, . . . , ECC41, as indicated in step 630. In accordance with the invention, each respective counter unit ECC11, . . . ECC41 comprises the component HW11, . . . , HW41 of the distributed system to which the unique component identification ID11, . . . , ID41 utilized is assigned.

Next, the counter value n, m1, m2, . . . , I is incremented after generation of the respective identifier EID11, . . . , EID41, as indicated in step 640.

Storing the incremented counter value n+1, m1+1, m2+1, . . . , I+1 is now stored as the respective current counter value in the counter unit ECC11, ECC41, as indicated in step 650.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for creating identifiers for information units in a distributed system, a respective way of functioning of the functional unit being defined by assignment of a respective information unit to a functional unit of the distributed system; the method comprising:
creating an identifier which is assigned for identification to the respective information unit upon generation of the respective information unit;
utilizing a unique component identification of a component of the distributed system for the identifier;
combining the unique component identification with a respective current counter value of a counter unit, each respective counter unit comprising the component of the distributed system to which the unique component identification utilized is assigned;
incrementing the counter value after generation of the respective identifier; and
storing the incremented counter value as the respective current counter value in the counter unit.

2. The method as claimed in claim 1, wherein access to the counter unit is at least restricted during generation of the information unit and the respective associated identifier.

3. The method as claimed in claim 1, wherein the counter unit is initialized with a defined start value.

4. The method as claimed in claim 2, wherein the counter unit is initialized with a defined start value.

5. The method as claimed in claim 1, wherein a generation unit generates the information unit and the respective associated identifier.

6. The method as claimed in claim 1, wherein the generation unit is implemented as a functional unit on the same component for which the respective information unit and the respective associated identifier is generated.

7. The method as claimed in claim 1, wherein the generation unit is implemented as a functional unit on a separate component, which is connected via at least one of (i) a direct communication connection and (ii) gateway unit to the respective component, for which the respective information unit and the respective associated identifier is generated.

8. The method as claimed in claim 1, wherein the respective information unit and the respective associated identifier are stored in a memory unit with at least one of (i) additional status and (ii) generation information.

9. The method as claimed in claim 8, wherein information stored in the memory unit for the respective identifiers created is processed with aid by the generation unit.

10. The method as claimed in claim 1, wherein additional identification information is utilized for the generation of the identifier for the respective information unit.

11. The method as claimed in claim 1, wherein the respective information unit and the respective associated identifier is stored after assignment to a respective functional unit in a non-volatile memory element.

12. The method as claimed in claim 1, wherein the component identification and the respective current counter value of the counter unit is stored in a non-volatile memory element on the respective component.

13. The method as claimed in claim 1, wherein the component identification, of the respective current counter value of the counter unit as well as the respective identifiers of the respective information units are stored encoded.
